(19) United States
(12) Patent Application Publication
(10) Pub. No.: US 2023/0080854 A1
(43) Pub. Date: Mar. 16, 2023

(54) NON-AQUEOUS ELECTROLYTE SECONDARY BATTERY

(71) Applicant: SANYO Electric Co., Ltd., Kadoma-shi, Osaka (JP)

(72) Inventors: Sho Urata, Tokushima (JP); Nobuhiro Sakitani, Tokushima (JP); Takaharu Morikawa, Osaka (JP)

(73) Assignee: SANYO Electric Co., Ltd., Kadoma-shi, Osaka (JP)

(21) Appl. No.: 17/796,746

(22) PCT Filed: Feb. 2, 2021
(86) PCT No.: PCT/JP2021/003704

§ 371 Date: Aug. 1, 2022

(30) Foreign Application Priority Data
Feb. 5, 2020 (JP) 2020-017722

(51) Int. Cl. H01M 10/0587; H01M 50/533; H01M 4/62; H01M 4/134

(52) U.S. Cl. CPC H01M 10/0587; H01M 50/533; H01M 4/622; H01M 4/134; H01M 2004/027

(57) ABSTRACT

The non-aqueous electrolyte secondary battery according to one embodiment of the present disclosure comprises a wound-type electrode body. A negative electrode has: a negative electrode current collector; a double-sided coated part in which a negative electrode mixture layer including a negative electrode active material and a binder is formed on the surface of the negative electrode current collector, and a negative electrode mixture layer is formed on both surfaces of the negative electrode current collector; and a one-sided coated part in which a negative electrode mixture layer is formed on one outer-periphery-side surface of the negative electrode current collector. At least a portion of the one-sided coated part is positioned on the outermost periphery of the electrode body. The swelling degree of the binder in the one-sided coated part is higher than the swelling degree of the binder in the double-sided coated part.

### TECHNICAL FIELD

The present disclosure relates to a non-aqueous electrolyte secondary battery.

### BACKGROUND ART

Conventionally widely used is a non-aqueous electrolyte secondary battery comprising: a wound electrode assembly in which a band-shaped positive electrode and a band-shaped negative electrode are wound with a separator interposed therebetween; and an exterior housing can that houses the wound electrode assembly. The electrodes of the electrode assembly (the positive electrode and the negative electrode) in such a wound battery each have a mixture layer including an active material and a binder on both surfaces of a metallic current collector. In typical, the separator is disposed on the outermost circumference of the electrode assembly, the positive electrode is connected to a sealing assembly, which is to be a lid of the exterior housing can to be an external terminal on the positive electrode side, with a positive electrode lead, and the negative electrode is connected to the exterior housing can, which is to be an external terminal on the negative electrode side, with a negative electrode lead. In a battery having such a constitution, since current from the band-shaped negative electrode concentrates at the negative electrode lead, an internal resistance is likely to be large.

Patent Literature 1 describes that a negative electrode is disposed on the outermost circumference of an electrode assembly, a negative electrode current collector is exposed as a one-surface coated portion eliminating a negative electrode mixture layer on a surface on an outer peripheral side of this outermost circumference, and the negative electrode current collector is directly contacted with an inner face of an exterior housing can to be electrically connected.
Patent Literature 2 describes binders having different degrees of swelling.

### CITATION LIST

### Patent Literatures

PATENT LITERATURE 1: International Publication No. WO2012/042830
PATENT LITERATURE 2: Japanese Unexamined Patent Application Publication No. 2012-182012

### SUMMARY

### Technical Problem

With some negative electrode active materials, a negative electrode mixture layer largely expands and contracts with charge and discharge, and an electrode assembly also expands and contracts with charge and discharge. When a negative electrode active material having a large amount of expansion with charge is used, the electrode assembly also largely expands to allow a negative electrode current collector on the outermost circumference to be sufficiently contacted with an inner surface of an exterior housing can, resulting in achievement of an electrical contact between a negative electrode and the exterior housing can. However, since the negative electrode active material having a large amount of expansion with charge largely contracts with discharge, it is difficult to sufficiently achieve the contact between the negative electrode current collector and the exterior housing can with discharge. Meanwhile, when a negative electrode active material having a small amount of expansion with charge is used, the negative electrode current collector on the outermost circumference and the exterior housing can is required to be contacted by reducing a clearance between the electrode assembly and the inner surface of the exterior housing can during the battery assembly since the amount of expansion of the electrode assembly is small with charge. If the clearance between the electrode assembly and the inner surface of the exterior housing can is small, insertion of the electrode assembly into the exterior housing can fail during the battery assembly.

The present disclosure regulates a degree of swelling of a binder to provide a non-aqueous electrolyte secondary battery that may achieve an appropriate electrical contact between an exposed surface of the negative electrode current collector on the outermost circumference and the inner surface of the exterior housing can.

### Solution to Problem

A non-aqueous electrolyte secondary battery of an aspect of the present disclosure is a non-aqueous electrolyte secondary battery, comprising: a wound electrode assembly in which a band-shaped positive electrode and a band-shaped negative electrode are wound with a separator interposed therebetween; and an exterior housing can that houses the electrode assembly, wherein the positive electrode has a positive electrode mixture layer formed on a surface of a sheet-shaped positive electrode current collector, the negative electrode has a negative electrode mixture layer formed on a surface of a sheet-shaped negative electrode current collector, the negative electrode mixture layer includes a rechargeable negative electrode active material and a binder, the negative electrode has a both-surface coated portion in which the negative electrode mixture layer is formed on both surfaces of the negative electrode current collector, and a one-surface coated portion in which the negative electrode mixture layer is formed on one surface of the negative electrode current collector, at least a part of the one-surface coated portion is disposed on an outermost circumference of the electrode assembly, at least a part of an exposed surface of the negative electrode current collector in the one-surface coated portion is contacted with an inner face of the exterior housing can, and a degree of swelling of the binder by an electrolyte liquid in the one-surface coated portion is larger than a degree of swelling of the binder in the both-surface coated portion.

### Advantageous Effect of Invention

The non-aqueous electrolyte secondary battery according to the present disclosure can achieve the certain contact between the exposed surface of the negative electrode current collector and the inner surface of the exterior housing can.

### BRIEF DESCRIPTION OF DRAWINGS

FIG. 1 is an axial sectional view of a cylindrical secondary battery of an example of an embodiment.

FIG. 2 is a perspective view of a wound electrode assembly comprised in the secondary battery illustrated in FIG. 1.

FIG. 3 is a front view of a positive electrode constituting an electrode assembly of an example of an embodiment illustrated with an unwound state.

FIG. 4A is a front view of a negative electrode constituting an electrode assembly of an example of an embodiment illustrated with an unwound state.

FIG. 4B is a longitudinal sectional view of a negative electrode constituting an electrode assembly of an example of an embodiment illustrated with an unwound state.

FIG. 5 is a radial sectional view of a negative electrode in proximity of the outermost circumference of an electrode assembly of an example of an embodiment.

FIG. 6 is a radial sectional view (a cross section viewed from the axial direction) of a part of proximity of the outermost circumference of an electrode assembly of an example of an embodiment.

### DESCRIPTION OF EMBODIMENTS

Hereinafter, an example of an embodiment of a cylindrical, wound non-aqueous electrolyte secondary battery according to the present disclosure will be described in detail with reference to the drawings. In the following description, specific shapes, materials, values, directions, and the like, which are examples for facilitating understanding of the present invention, may be appropriately modified with specifications of cylindrical secondary batteries. When a plurality of embodiments and modified examples are included in the following description, use in appropriate combination of characteristic portions thereof are anticipated in advance.

“Entire Constitution of Battery”

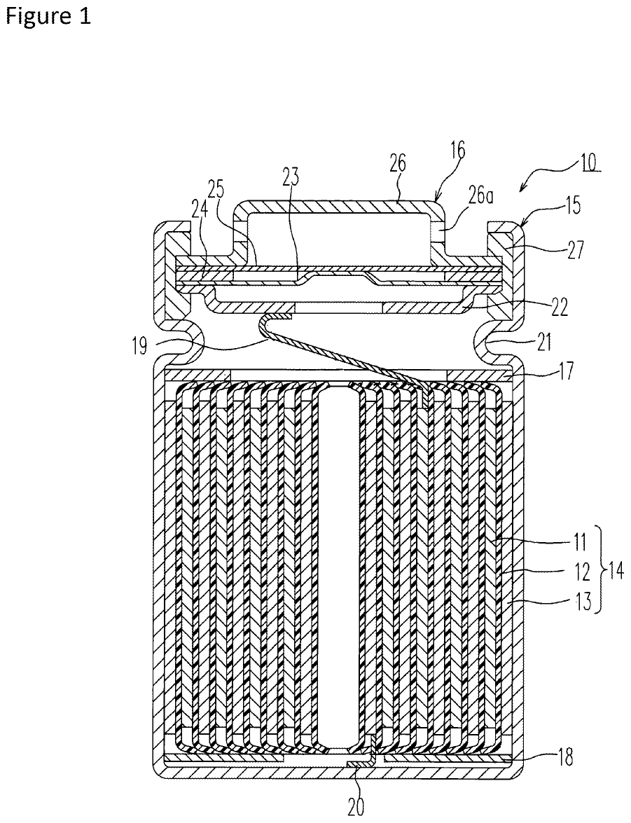

FIG. 1 is an axial sectional view of a wound secondary battery 10 of an example of an embodiment. Although the secondary battery 10 illustrated in FIG. 1 has a cylindrical shape, the secondary battery 10 may have a rectangular shape or the like as long as it is the wound type battery. In the secondary battery 10 illustrated in FIG. 1, an electrode assembly 14 and a non-aqueous electrolyte (not illustrated) are housed in an exterior housing can 15. The electrode assembly 14 has a wound structure in which a positive electrode 11 and a negative electrode 12 are wound with a separator 13 interposed therebetween. For a non-aqueous solvent of the non-aqueous electrolyte (organic solvent), carbonates, lactones, ethers, ketones, esters, and the like may be used, and two or more of these solvents may be mixed to be used. When two or more of the solvent are mixed to be used, a mixed solvent including a cyclic carbonate and a chain carbonate is preferably used. For example, ethylene carbonate (EC), propylene carbonate (PC), butylene carbonate (BC), and the like may be used as the cyclic carbonate, and dimethyl carbonate (DMC), ethyl methyl carbonate (EMC), diethyl carbonate (DEC), and the like may be used as the chain carbonate. For an electrolyte salt in the non-aqueous electrolyte. LiPF₆, LiBF₄, LiCF₃SO₃, and the like, and a mixture thereof may be used. An amount of the electrolyte salt dissolved in the non-aqueous solvent may be, for example, 0.5 to 2.0 mol/L. Hereinafter, for convenience of description, the sealing assembly 16 side will be described as “the upper side”, and the bottom side of the exterior housing can 15 will be described as “the lower side”.

An opening end of the exterior housing can 15 is capped with the sealing assembly 16 to seal inside the secondary battery 10. Insulating plates 17 and 18 are provided on the upper and lower sides of the electrode assembly 14, respectively. A positive electrode lead 19 extends upward through a through hole of the insulating plate 17, and welded with the lower face of a filter 22, which is a bottom plate of the sealing assembly 16. In the secondary battery 10, a cap 26, which is a top plate of the sealing assembly 16 electrically connected to the filter 22, becomes a positive electrode terminal. Meanwhile, a negative electrode lead 20 extends through a through hole of the insulating plate 18 toward the bottom side of the exterior housing can 15, and welded with a bottom inner face of the exterior housing can 15. In the secondary battery 10, the exterior housing can 15 becomes a negative electrode terminal.

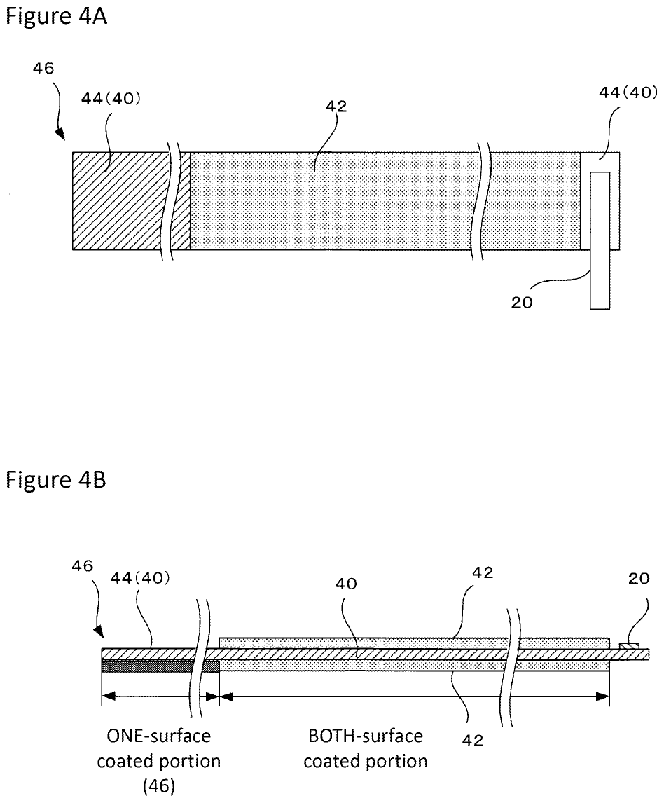

As described later, a negative electrode current collector 40 in a one-surface coated portion 46 (see FIG. 4A and FIG. 4B) is exposed on the outermost circumference of the electrode assembly 14, and this exposed surface of the negative electrode current collector 40 is contacted with the inner face of the exterior housing can 15 to electrically connect the negative electrode 12 and the exterior housing can 15.

The exterior housing can 15 is, for example, a bottomed cylindrical metallic exterior housing can. A gasket 27 is provided between the exterior housing can 15 and the sealing assembly 16 to electrically insulate the exterior housing can 15 and the sealing assembly 16, and to achieve sealability inside the secondary battery 10. The exterior housing can 15 has a grooved part 21 formed by, for example, pressing the side part thereof from the outside to support the sealing assembly 16. The grooved part 21 is preferably formed circularly along the circumferential direction of the exterior housing can 15, and supports the sealing assembly 16 with the upper face of the grooved part 21.

The sealing assembly 16 has a stacked structure of a filter 22, a lower vent member 23, an insulating member 24, an upper vent member 25, and a cap 26 in this order from the electrode assembly 14 side. Each member constituting the sealing assembly 16 has, for example, a disk shape or a ring shape, and each member except for the insulating member 24 is electrically connected each other. The lower vent member 23 and the upper vent member 25 are connected each other at each of central parts thereof, and the insulating member 24 is interposed between each of the circumferential parts of the vent members 23 and 25. If the internal pressure of the battery increases with abnormal heat generation, for example, the lower vent member 23 breaks and the upper vent member 25 expands toward the cap 26 side to be separated from the lower vent member 23, resulting in cutting off of an electrical connection between the both members. If the internal pressure further increases, the upper vent member 25 breaks, and gas is discharged through an opening 26a of the cap 26.

“Construction of Electrode Assembly”

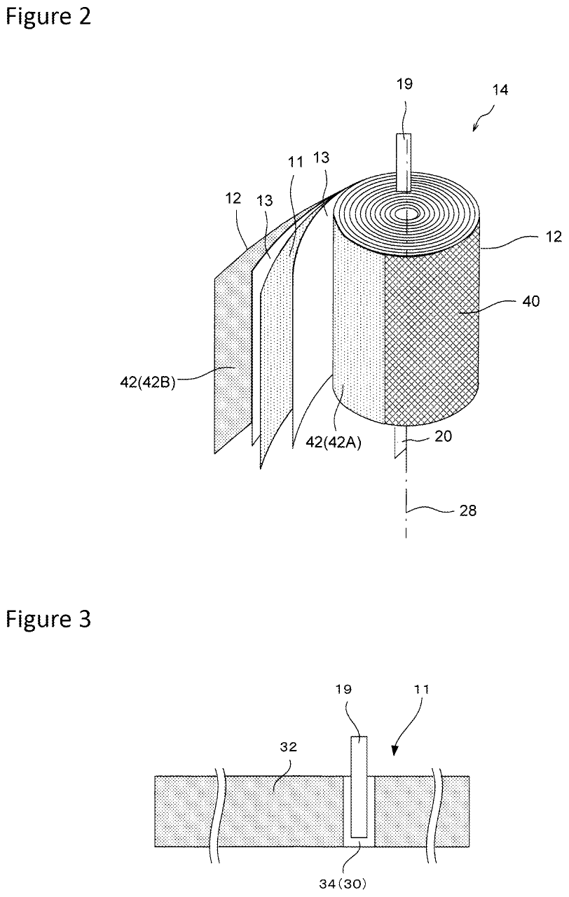

Next, the electrode assembly 14 will be described with reference to FIG. 2. FIG. 2 is a perspective view of the electrode assembly 14. As described above, the electrode assembly 14 has a wound structure in which the positive electrode 11 and the negative electrode 12 are spirally wound with the separator 13 interposed therebetween. Any of the positive electrode 11, the negative electrode 12, and the separator 13 is formed in a band shaped, and spirally wound around a winding core disposed along a winding axis 28 to be alternately stacked in the radial direction of the electrode assembly 14. In the radial direction, the winding axis 28 side is referred to as the inner peripheral side, and the opposite side is referred to as the outer peripheral side. In the electrode assembly 14, the longitudinal direction of the positive electrode 11 and negative electrode 12 corresponds to a winding direction, and the width direction of the positive electrode 11 and negative electrode 12 corresponds to an axial direction. The positive electrode lead 19 extends, on the upper end of the electrode assembly 14 toward the axial direction, from a substantial center between the center and the outermost circumference in the radial direction. The negative electrode lead 20 extends, on the lower end of the electrode assembly 14, toward the axial direction from near the winding axis 28.

For the separator 13, a porous sheet having an ion permeation property and an insulation property is used. Specific examples of the porous sheet include a fine porous thin film, a woven fabric, and a nonwoven fabric. As a material of the separator 13, an olefin resin such as polyethylene and polypropylene is preferable. A thickness of the separator 13 is, for example, 10 μm to 50 μm. The separator 13 has tended to be thinned as higher capacity and higher output of the battery. The separator 13 has a melting point of, for example, approximately 130° C. to 180° C.

“Construction of Positive Electrode”

Next, FIG. 3 is a front view of the positive electrode 11 constituting the electrode assembly 14. In FIG. 3, the positive electrode 11 is illustrated with an unwound state.

The positive electrode 11 has the band-shaped positive electrode current collector 30 and the positive electrode mixture layer 32 formed on the positive electrode current collector 30. The positive electrode mixture layer 32 is formed on at least one of the inner peripheral side and outer peripheral side of the positive electrode current collector 30. For the positive electrode current collector 30, a foil of a metal, such as aluminum, a film in which such a metal is disposed on a surface layer thereof, and the like are used, for example. A preferable positive electrode current collector 30 is a foil of aluminum or of a metal mainly composed of an aluminum alloy. A thickness of the positive electrode current collector 30 is, for example, 10 μm to 30 μm.

The positive electrode mixture layer 32 is preferably formed on an entire region of both surfaces of the positive electrode current collector 30 except for a positive electrode current collector exposed part 34, described later. The positive electrode mixture layer 32 preferably includes a positive electrode active material, a conductive agent, and a binder. The positive electrode mixture layer 32 is formed by applying a positive electrode mixture slurry including the positive electrode active material, the conductive agent, the binder, and a solvent such as N-methyl-2-pyrrolidone (NMP) on both the surfaces of the positive electrode current collector 30 to be dried (positive electrode mixture layer forming step). Then, the positive electrode mixture layer 32 is compressed.

Examples of the positive electrode active material may include a lithium-containing transition metal oxide containing a transition metal element such as Co, Mn, and Ni. The lithium-containing transition metal oxide is not particularly limited, and preferably a composite oxide represented by the general formula Li₁₊ₓMO₂ (in the formula, −0.2<x≤0.2 and M includes at least one of the group consisting of Ni, Co, Mn, and Al).

Examples of the conductive agent included in the positive electrode mixture layer 32 may include carbon materials such as carbon black (CB), acetylene black (AB), Ketjenblack, and graphite.

Examples of the binder included in the positive electrode mixture layer 32 include fluororesins such as polytetrafluoroethylene (PTFE) and polyvinylidene fluoride (PVdF), polyacrylonitrile (PAN), a polyimide (PI), an acrylic resin, and a polyolefin resin. When the positive electrode mixture slurry is prepared in an aqueous solvent, styrene-butadiene rubber (SBR), nitrile rubber (NBR), CMC or a salt thereof, polyacrylic acid or a salt thereof, polyvinyl alcohol, and the like may be used. These materials may be used singly, and may be used in combination of two or more thereof. A content of the binder in the positive electrode mixture layer 32 is 0.5 mass % to 10 mass %, and preferably 0.5 mass % to 5 mass %.

On the positive electrode 11, the positive electrode current collector exposed part 34 in which a surface of the positive electrode current collector 30 is exposed is provided. The positive electrode current collector exposed part 34 is a portion to which the positive electrode lead 19 is connected and a portion in which a surface of the positive electrode current collector 30 is uncovered with the positive electrode mixture layer 32. The positive electrode current collector exposed part 34 is formed to be wider in the longitudinal direction than the positive electrode lead 19. The positive electrode current collector exposed part 34 is preferably provided on both surfaces of the positive electrode 11 to be stacked in the thickness direction of the positive electrode 11. The positive electrode lead 19 is bonded to the positive electrode current collector exposed part 34 with, for example, ultrasonic welding.

In the example illustrated in FIG. 3, the positive electrode current collector exposed part 34 is provided on the central part in the longitudinal direction of the positive electrode 11 and over an entire length in the width direction. The positive electrode current collector exposed part 34 may be formed on the initial end part or terminal end part of the positive electrode 11, and is preferably provided at a position of substantially same distance from the initial end part and the terminal end part from a viewpoint of current collectability. The positive electrode lead 19 connected to the positive electrode current collector exposed part 34 provided at such a position allows the positive electrode lead 19 to be disposed to project upward from the end surface in the width direction at a medial position in the radial direction of the electrode assembly 14 when wounded as the electrode assembly 14. The positive electrode current collector exposed part 34 is provided by, for example, intermittent application in which the positive electrode mixture slurry is not applied on a part of the positive electrode current collector 30.

“Constitution of Negative Electrode”

FIG. 4A is a front view of the negative electrode 12 constituting the electrode assembly 14 illustrated with an unwound state, and FIG. 4B is a longitudinal sectional view thereof.

In the electrode assembly 14, the negative electrode 12 is formed to be larger than the positive electrode 11 to prevent precipitation of lithium on the negative electrode 12. Specifically, a length in the width direction (axial direction) of the negative electrode 12 is larger than a length in the width direction of the positive electrode 11. In addition, a length in the longitudinal direction of the negative electrode 12 is larger than a length in the longitudinal direction of the positive electrode 11. As a result, at least a portion on which the positive electrode mixture layer 32 of the positive electrode 11 is formed is disposed opposite to a portion on which the negative electrode mixture layer 42 of the negative electrode 12 is formed with the separator 13 interposed therebetween when wound as the electrode assembly 14.

As illustrated in FIG. 4A and FIG. 4B, the negative electrode 12 has the band-shaped negative electrode current collector 40 and the negative electrode mixture layer 42 formed on both surfaces of the negative electrode current collector 40. For the negative electrode current collector 40, a foil of a metal such as copper, a film in which such a metal is disposed on a surface layer thereof, or the like is used, for example. A thickness of the negative electrode current collector 40 is, for example, 5 μm to 30 μm.

The negative electrode mixture layer 42 is preferably formed on an entire region of both the surfaces of the negative electrode current collector 40 except for a negative electrode current collector exposed part 44 and a one-surface coated portion 46, described later. The negative electrode mixture layer 42 preferably includes a negative electrode active material and a binder. The negative electrode mixture layer 42 is formed by applying a negative electrode mixture slurry including the negative electrode active material, the binder, and a solvent such as water on both the surfaces of the negative electrode current collector 40 to be dried (negative electrode mixture layer forming step). Then, the negative electrode mixture layer 42 is compressed.

In the examples illustrated in FIG. 4A and FIG. 4B, the negative electrode current collector exposed part 44 is provided on the initial end part in the longitudinal direction of the negative electrode 12 and over an entire length in the width direction of the current collector. The negative electrode current collector exposed part 44 is a portion to which the negative electrode lead 20 is connected and a portion in which a surface of the negative electrode current collector 40 is uncovered with the negative electrode mixture layer 42. The negative electrode current collector exposed part 44 is formed to be wider in the longitudinal direction than a width of the negative electrode lead 20. The negative electrode current collector exposed part 44 is preferably provided on both surfaces of the negative electrode 12 to be stacked in the thickness direction of the negative electrode 12.

In the present embodiment, the negative electrode lead 20 is bonded to a surface on the inner peripheral side of the negative electrode current collector 40 with, for example, ultrasonic welding. One end part of the negative electrode lead 20 is disposed on the negative electrode current collector exposed part 44, and the other end part extends downward from the lower end of the negative electrode current collector exposed part 44. The negative electrode current collector exposed part 44 is provided by, for example, intermittent application in which the negative electrode mixture slurry is not applied on a part of the negative electrode current collector 40.

On a terminal end part of the negative electrode 12 disposed on the outermost peripheral side of the electrode assembly 14, a one-surface coated portion 46 in which the negative electrode mixture layer 42 is formed only on a surface of the inner peripheral side of the negative electrode current collector 40 is provided, and the negative electrode current collector 40 is exposed on a surface of the outer peripheral side (a surface positioned on the outer side when wounded) of the one-surface coated portion 46. A degree of swelling of the binder by an electrolyte liquid in the one-surface coated portion 46 is larger than a degree of swelling of the binder by an electrolyte liquid in the both-surface coated portion.

The negative electrode current collector 40 exposed in the one-surface coated portion 46 is contacted with the inner face of the exterior housing can 15 (see FIG. 1), and separately to the negative electrode lead 20, the negative electrode 12 and the exterior housing can 15 are electrically connected. The negative electrode current collector exposed part 44 and the one-surface coated portion 46 are preferably provided by, for example, intermittent application in which the negative electrode mixture slurry is not applied on a part of the negative electrode current collector 40.

The negative electrode active material is not particularly limited as long as it may reversibly occlude and release lithium (Li) ions, and for example, carbon materials such as natural graphite and artificial graphite, metals that form an alloy with lithium such as silicon (Si) and tin (Sn), or an alloy or oxide including them may be used.

The binder included in the negative electrode mixture layer 42 is typically made of resin, and examples thereof include fluororesins such as polytetrafluoroethylene (PTFE) and polyvinylidene fluoride (PVdF), polyacrylonitrile (PAN), a polyimide (PI), an acrylic resin, and a polyolefin resin. When the negative electrode mixture slurry is prepared in an aqueous solvent, styrene-butadiene rubber (SBR), nitrile rubber (NBR). CMC or a salt thereof, polyacrylic acid or a salt thereof, polyvinyl alcohol, and the like may be used. The binder is preferably a rubber resin having a repeating molecular structure of double bonds and single bonds, such as SBR and NBR, from a viewpoint of flexibility of the negative electrode 12. These materials may be used singly, and may be used in combination of two or more thereof. A content of the binder in the negative electrode mixture layer 42 is 0.5 mass % to 10 mass %, and preferably 0.5 mass % to 5 mass %.

“Constitution in Proximity of Outermost Circumference of Electrode Assembly”

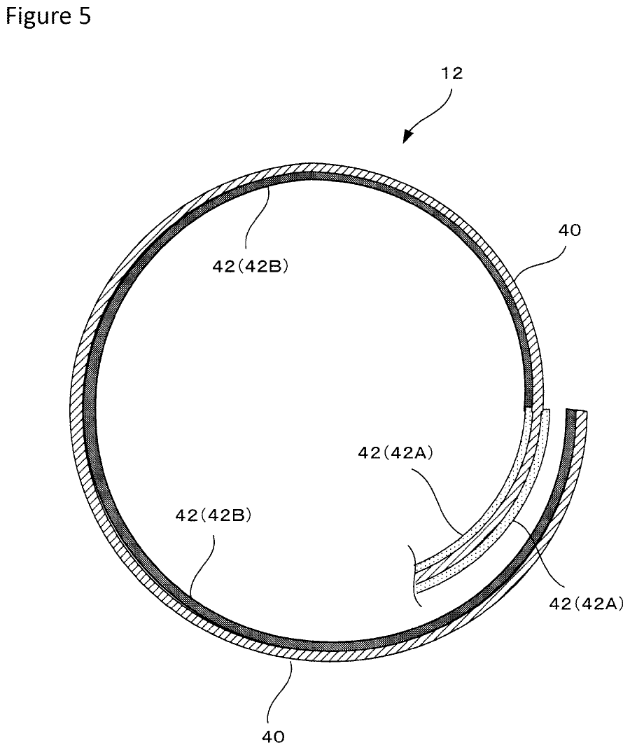

FIG. 5 is a view schematically illustrating a axial cross section of proximity of the outermost circumference of the negative electrode 12 (the positive electrode 11 and the separator 13 are omitted). As illustrated, the negative electrode mixture layer 42 is absent on the outer peripheral side of the negative electrode 12 of the outermost circumference, and the negative electrode current collector 40 is exposed.

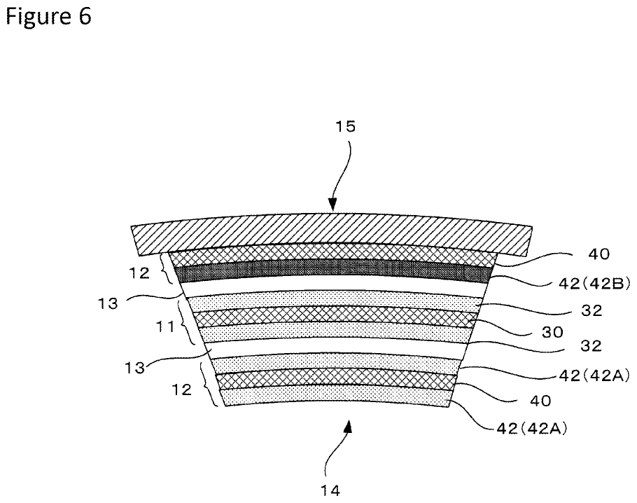

FIG. 6 is a radial sectional view (a cross section viewed from the axial direction) of a part of proximity of the outermost circumference of the electrode assembly 14. As illustrated, the negative electrode 12 is positioned on the inner peripheral side of the exterior housing can 15, the negative electrode current collector 40 is exposed on the outer peripheral side of the negative electrode 12, and this exposed surface of the negative electrode current collector 40 is contacted with the inner face of the exterior housing can 15. Inside the negative electrode 12, the positive electrode 11 in which the positive electrode mixture layer 32 is formed on both the side of the positive electrode current collector 30 is positioned with the separator 13 interposed therebetween. Inside the positive electrode 11, the negative electrode 12 is positioned with the separator 13 interposed therebetween.

This negative electrode mixture layer 42 (42B) in the one-surface coated portion 46 disposed on the outermost circumference has a property different from the negative electrode mixture layer 42 (42A) in the both-surface coated portion on the inner peripheral side. That is, in the negative electrode 12 of the non-aqueous electrolyte secondary battery of the present embodiment, the binder in the one-surface coated portion 46 is constituted by using a material having a larger degree of swelling by the electrolyte liquid than the binder in the both-surface coated portion.

“Regulation of Degree of Swelling of Binder”

Examples of a method of regulating the degree of swelling of the binder include the following method. For example, in a styrene-butadiene rubber (SBR), adding acrylonitrile as its constituent monomer increases the degree of swelling. Accordingly, when the styrene-butadiene rubber (SBR) is used for the binder, regulating an amount of acrylonitrile added may regulate the degree of swelling of the binder. In addition, since the degree of swelling differs depending on a type of the binder as described in Patent Literature 2, binders having different degrees of swelling may be used.

As above, in the present embodiment, used for the binder in the one-surface coated portion 46 is a binder having a larger degree of swelling by the electrolyte liquid than the binder in the both-surface coated portion. The degree of swelling of the binder in the one-surface coated portion 46 is preferably 1.2 to 2.1 times larger than the degree of swelling of the binder in the both-surface coated portion.

This configuration allows the negative electrode mixture layer 42B in the one-surface coated portion on the outermost circumference to swell, and may allow to maintain the good current collectability by contacting the exposed surface of the negative electrode current collector 40 and the inner face of the exterior housing can 15 even with discharge.

When a degree of swelling of the entire binder is enlarged, adhesiveness between the negative electrode active material and the negative electrode current collector is lowered, and peeling between the negative electrode active material and the negative electrode current collector 40 occurs due to the expansion and contraction of the active material with charge and discharge, leading to significant initial deterioration due to lowering of the current collectability. When the degree of swelling of the entire binder is reduced, current collectability with discharge by the contact between the exposed surface of the negative electrode current collector and the inner surface of the exterior housing can is poor, leading to deteriorated output. Enlarging the degree of swelling of only the binder in the one-surface coated portion 46 improves the output characteristics even with discharge without large initial deterioration.

In the present embodiment, an entirety of the one-surface coated portion 46 is disposed on the outermost circumference of the electrode assembly 14, but the range where the one-surface coated portion 46 is disposed does not necessarily coincide with the outermost circumference of the electrode assembly 14. As long as at least a part of the one-surface coated portion 46 is disposed on the outermost circumference of the electrode assembly 14, at least a part of the exposed surface of the negative electrode current collector 40 may be sufficiently contacted with the inner face of the exterior housing can. For example, the one-surface coated portion 46 is preferably disposed within a range of 50% or more of a circumference length of the outermost circumference of the electrode assembly 14. A part of the one-surface coated portion 46 may be disposed so as to extend toward the initial winding side from the outermost circumference of the electrode assembly 14. In this case, as illustrated in FIG. 6, the inner peripheral side of the positive electrode mixture layer 32 is required to be opposite to the outer peripheral side of the negative electrode mixture layer 42 with the separator 13 interposed therebetween, and thereby the one-surface coated portion 46 is formed from the terminal end part of the negative electrode 12 within a range not to exceed a position opposite to the terminal end of the inner peripheral side of the positive electrode mixture layer 32. Accordingly, the lowering of adhesiveness between the negative electrode active material and the negative electrode current collector is inhibited.

The above effect of improvement in the characteristics is remarkably exhibited with larger expansion and contraction of the negative electrode mixture layer 42. When a silicon material including Si or a tin material including Sn is used for the negative electrode active material, the negative electrode mixture layer 42 largely expands and contracts. The negative electrode mixture layer 42 preferably includes the silicon material in the present embodiment. Examples of the silicon material include an oxide of Si and lithium silicate. As the oxide of Si, a composite in which Si particles are dispersed in a SiO₂ phase may be used, for example. The silicon material is preferably used with the carbon material.

The electrode assembly 14 may be easily inserted into the exterior housing can 15 by providing a clearance with the inner surface of the exterior housing can 15. The electrode assembly 14 inserted into the exterior housing can 15 swells with the electrolyte liquid to have an enlarged diameter, and the exposed surface of the negative electrode current collector 40 on the outermost circumference is contacted with the inner surface of the exterior housing can 15. Although the negative electrode mixture layer 42 contracts with discharge, the negative electrode mixture layer 42 (42B) in the one-surface coated portion 46 disposed on the outermost circumference of the electrode assembly 14 maintains the swelled state, and thereby the electrical connection between the exposed surface of the negative electrode current collector 40 and the exterior housing can 15 is maintained. In addition, since the negative electrode lead 20 achieves the electrical connection between the negative electrode 12 and the exterior housing can 15, the certain initial charge may be performed but the negative electrode lead may be eliminated.

### EXAMPLES

The present disclosure will be further described below with Examples, but the present disclosure is not limited to these Examples.

### Example 1

[Production of Negative Electrode]

As a negative electrode active material, 95 parts by mass of a graphite powder, 5 parts by mass of an oxide of Si (for example, SiO), 1 part by mass of carboxymethyl cellulose (CMC), and an appropriate amount of water were mixed. Into this mixture, 1.0 part by mass of a styrene-butadiene rubber (SBR) as a binder was mixed to prepare a first negative electrode mixture slurry. The styrene-butadiene rubber (referred to as styrene-butadiene rubber A) had a degree of swelling of 140.

The styrene-butadiene rubber A in the first negative electrode mixture slurry was replaced with a styrene-butadiene rubber B having a different degree of swelling to prepare a second negative electrode mixture slurry. The styrene-butadiene rubber B had a degree of swelling of 170.

Then, the first negative electrode mixture slurry was applied with a predetermined range on one surface of a band-shaped negative electrode current collector made of a copper foil having a thickness of 8 μm, and then the applied film was dried to form a negative electrode mixture layer 42 (42A) in a both-surface coated portion. Subsequently, the second negative electrode mixture slurry was applied on one surface of an uncoated region adjacent to the region where the first negative electrode mixture slurry was applied on the identical surface of the negative electrode current collector, and the applied film was dried to form a negative electrode mixture layer 42 (42B) in a one-surface coated portion. In a similar manner, the negative electrode mixture layer 42 (42A) was formed by using the first negative electrode mixture slurry on the opposite side to the preformed negative electrode mixture layer 42 (42A) in the both-surface coated portion across the negative electrode current collector.

An amount of the applied negative electrode mixture was 282 g/m² in total of both the surfaces. Then, the negative electrode mixture was rolled by using a roller so that the negative electrode mixture layer had a filling density of 1.60 g/mL, the dried applied film was compressed, and then cut to a predetermined electrode plate size to produce a negative electrode in which the negative electrode mixture layer on the outer peripheral side was formed on one surface of the negative electrode current collector and in which the negative electrode mixture layer on the inner peripheral side was formed on the other surface. A negative electrode current collector exposed part in which the mixture layer was absent on the initial end part and the current collector surface was exposed was provided, and a negative electrode lead made of nickel/copper was welded with the negative electrode current collector exposed part.

[Production of Positive Electrode]

With 100 parts by mass of particles of lithium nickel-cobalt-aluminate represented by LiNi_{0.88}Co_{0.09}Al_{0.03}O₂, 0.8 parts by mass of carbon black as a carbon conductive agent and 0.7 parts by mass of polyvinylidene fluoride (PVdF) as a binder were mixed, and an appropriate amount of N-methyl-2-pyrrolidone (NMP) was further added to prepare a positive electrode mixture slurry. Then, the prepared positive electrode mixture slurry was applied on both surfaces of a positive electrode current collector including aluminum and having a thickness of 15 μm, and dried. An amount of the applied positive electrode mixture was set to 560 g/m² in total of both the surfaces. Thereafter, the positive electrode mixture was rolled by using a roller so that the positive electrode mixture layer had a filling density of 3.60 g/mL, and cut to a predetermined electrode size to produce a positive electrode.

[Production of Electrode Assembly]

Used for producing a cylindrical wound electrode assembly were one sheet of the above positive electrode, one sheet of the above negative electrode, and one sheet of a separator composed of a fine porous film made of polyethylene. First, the positive electrode and the negative electrode were disposed opposite to each other with the separator interposed therebetween with insulated state. Then, a stacked body of the positive electrode, the separator, and the negative electrode was spirally wound by using a cylindrical winding core. In this time, the exposed surface of the negative electrode current collector in the one-surface coated portion of the electrode assembly was constructed so as to be exposed on the outermost circumference of the electrode assembly. The negative electrode lead provided in the uncoated part on the innermost side was folded to be inserted into a bottomed cylindrical exterior housing can made of nickel-plated iron.

A rate of a diameter of the electrode assembly before insertion to an inner diameter of the exterior housing can was 98%.

[Preparation of Non-Aqueous Electrolyte]

Into a mixed solvent of ethylene carbonate (EC), dimethyl carbonate (DMC), and ethyl methyl carbonate (EMC) at a volume ratio of 20:60:20, vinylene carbonate (VC) was dissolved at 2 mass %. Lithium hexafluorophosphate (LiPF₆) as an electrolyte was further dissolved so as to have a concentration of 1.3 mole/litter into the above mixed solvent to prepare a non-aqueous electrolyte.

[Production of Battery]

Into the exterior housing can that houses the electrode assembly, 5.2 g of the non-aqueous electrolyte prepared as above was injected. An opening end of the exterior housing can was calked with a gasket to be sealed. As above, a 18650-sized cylindrical non-aqueous electrolyte secondary battery was produced.

[Regulation of Degree of Swelling of Binder]

As described above, in a styrene-butadiene rubber (SBR), adding acrylonitrile as its constituent monomer increases the degree of swelling. Thus, an amount of acrylonitrile added was regulated to regulate the degree of swelling of the binder.

[Measurement of Direct-Current Resistance (DCR)]

The battery was charged at a constant current of 0.5 It until 4.2 V. The battery was further charged at a constant voltage of 4.2 V until a current reached 0.05 It. Then, the battery was discharged at a constant current of 0.2 It until a voltage reached 2.5 V to measure a discharge capacity.

A charging depth of the battery (State of Charge: SOC) was adjusted to 10% from the above result of the discharge capacity, and then the battery was discharged at a current of 1.0 It for 10 seconds to measure a change in voltage ΔV at a time after the 10 seconds. From the change in voltage ΔV and the current value in the discharge, a direct-current resistance DCR was determined. It is to be noted that It (A)=Rated Capacity (Ah)/1 (h).

DCR=ΔV/1.0It

[Measurement of Capacity Retention]

The battery was charged and discharged under the same condition as in the above measurement method of the discharge capacity with 100 cycles to calculate a capacity retention with the following formula.

Capacity Retention=(Discharge Capacity at 100th Cycle/Discharge Capacity at 1st Cycle)×100

[Measurement of Degree of Swelling of Binder]

An aqueous dispersion of the binder (SBR) was dried with a warm air dryer at 80° C. to produce an SBR film, and a mass of this film was measured. Then, the film was immersed for 24 hours in the electrolyte liquid used in the battery production. Thereafter, the film was taken up, an extra electrolyte liquid on the surface was wiped to measure the mass again. From a mass ratio between before and after the immersion in the electrolyte liquid, a degree of swelling was calculated.

Degree of Swelling (%)=(Mass of Film after Immersion/Mass of Film before Immersion)×100

### Comparative Example 1

A non-aqueous electrolyte secondary battery was produced in the same manner as in Example 1 except that the negative electrode mixture layer 42B was formed by using the first negative electrode mixture slurry in the negative electrode production in Example 1.

### Example 2

A non-aqueous electrolyte secondary battery was produced in the same manner as in Example 1 except that the SBR mixed with the second negative electrode mixture slurry was replaced with a styrene-butadiene rubber C in the negative electrode production in Example 1. The styrene-butadiene rubber C had a degree of swelling of 300.

### Comparative Example 2

A non-aqueous electrolyte secondary battery was produced in the same manner as in Example 1 except that the SBR mixed with the second negative electrode mixture slurry was replaced with a styrene-butadiene rubber D in the negative electrode production in Example 1. The styrene-butadiene rubber D had a degree of swelling of 340.

### Comparative Example 3

A non-aqueous electrolyte secondary battery was produced in the same manner as in Comparative Example 1 except that the amount of the graphite powder mixed with the negative electrode mixture slurry was changed to 100 parts by mass, the amount of the oxide of Si was changed to 0 parts by mass, and the amount of the applied negative electrode mixture was changed to 344 g/m², in the negative electrode production in Comparative Example 1.

### Example 3

A non-aqueous electrolyte secondary battery was produced in the same manner as in Example 1 except that the amount of the graphite powder mixed with the negative electrode mixture slurry was changed to 100 parts by mass, the amount of the oxide of Si was changed to 0 parts by mass, and the amount of the applied negative electrode mixture was changed to 344 g/m², in the negative electrode production in Example 1.

### Comparative Example 4

A non-aqueous electrolyte secondary battery was produced in the same manner as in Comparative Example 1 except that the amount of the graphite powder mixed with the negative electrode mixture slurry was changed to 99 parts by mass, the amount of the oxide of Si was changed to 1 part by mass, and the amount of the applied mixture was changed to 330 g/m², in the negative electrode production in Comparative Example 1.

### Example 4

A non-aqueous electrolyte secondary battery was produced in the same manner as in Example 1 except that the amount of the graphite powder mixed with the negative electrode mixture slurry was changed to 99 pails by mass, the amount of the oxide of Si was changed to 1 part by mass, and the amount of the applied mixture was changed to 330 g/m², in the negative electrode production in Example 1.

### Comparative Example 5

A non-aqueous electrolyte secondary battery was produced in the same manner as in Comparative Example 1 except that the amount of the graphite powder mixed with the negative electrode mixture slurry was changed to 97 parts by mass, the amount of the oxide of Si was changed to 3 parts by mass, and the amount of the applied mixture was changed to 304 g/m², in the negative electrode production in Comparative Example 1.

### Example 5

A non-aqueous electrolyte secondary battery was produced in the same manner as in Example 1 except that the amount of the graphite powder mixed with the negative electrode mixture slurry was changed to 97 parts by mass, the amount of the oxide of Si was changed to 3 parts by mass, and the amount of the applied mixture was changed to 304 g/m², in the negative electrode production in Example 1.

### Comparative Example 6

A non-aqueous electrolyte secondary battery was produced in the same manner as in Comparative Example 1 except that the amount of the graphite powder mixed with the negative electrode mixture slurry was changed to 90 parts by mass, the amount of the oxide of Si was changed to 10 parts by mass, and the amount of the applied mixture was changed to 239 g/m², in the negative electrode production in Comparative Example 1.

### Example 6

A non-aqueous electrolyte secondary battery was produced in the same manner as in Example 1 except that the amount of the graphite powder mixed with the negative electrode mixture slurry was changed to 90 parts by mass, the amount of the oxide of Si was changed to 10 parts by mass, and the amount of the applied mixture was changed to 239 g/m², in the negative electrode production in Example 1.

### Results

Table 1 shows the test results of the non-aqueous electrolyte secondary batteries in Examples and Comparative Examples.

TABLE 1

| | | | | | Degree of swelling | | | |
|---|---|---|---|---|---|---|---|---|
| | | | SBR | | in one-surface | | | |
| | | | Both- | One- | coated portion/ | | | |
| | Content | | surface | surface | Degree of swelling | | | |
| | of silicon | | coated | coated | in both-surface | | | Capacity |
| | material | | portion | portion | coated portion | DCR | | retention |
| Comparative | 5 | mass % | A | A | 1 | 68 | mΩ | 92% |
| Example 1 | | | | | | | | |
| Example 1 | 5 | mass % | A | B | 1.2 | 63 | mΩ | 92% |
| Example 2 | 5 | mass % | A | C | 2.1 | 60 | mΩ | 92% |
| Comparative | 5 | mass % | A | D | 2.4 | 59 | mΩ | 90% |
| Example 2 | | | | | | | | |
| Comparative | 0 | mass % | A | B | 1 | 119 | mΩ | 93% |
| Example 3 | | | | | | | | |
| Example 3 | 0 | mass % | A | B | 1.2 | 115 | mΩ | 93% |
| Comparative | 1 | mass % | A | A | 1 | 109 | mΩ | 93% |
| Example 4 | | | | | | | | |
| Example 4 | 1 | mass % | A | B | 1.2 | 105 | mΩ | 93% |
| Comparative | 3 | mass % | A | A | 1 | 83 | mΩ | 93% |
| Example 5 | | | | | | | | |
| Example 5 | 3 | mass % | A | B | 1.2 | 79 | mΩ | 93% |
| Comparative | 10 | mass % | A | A | 1 | 55 | mΩ | 90% |
| Example 6 | | | | | | | | |
| Example 6 | 10 | mass % | A | B | 1.2 | 49 | mΩ | 90% |

As shown in Table 1, Examples 1 and 2 are found to have no lowering of the capacity retention, a reduced DCR with SOC 10%, and improved output characteristics even with discharge in the terminal stage, compared with Comparative Example 1. It is considered that setting the degree of swelling of the binder in the one-surface coated portion to be larger than the degree of swelling of the binder in the both-surface coated portion maintains the contact between the exposed surface of the negative electrode current collector and the exterior housing can even with a state of progressed discharge.

Comparative Example 2 has a reduced DCR with SOC 10%, but had lowered capacity retention compared with Comparative Example 1. In order to inhibit the lowering of the capacity retention and to reduce DCR, the degree of swelling of the binder in the one-surface coated portion is preferably 1.2 to 2.1 times larger than the degree of swelling of the binder in the both-surface coated portion.

Increase in the content of the oxide of Si as the silicon material in the negative electrode active material enlarges the effect of reducing DCR by increasing the degree of swelling of the binder in the one-surface coated portion.

### REFERENCE SIGNS LIST

10 Secondary battery, 11 Positive electrode, 12 Negative electrode, 13 Separator, 14 Electrode assembly, 15 Exterior housing can. 16 Sealing assembly, 17, 18 Insulating plate, 19 Positive electrode lead, 20 Negative electrode lead, 21 Grooved part, 22 Filter, 23 Lower vent member, 24 Insulating member, 25 Upper vent member. 26 Cap, 26a Opening, 27 Gasket, 28 Winding axis, 30 Positive electrode current collector, 32 Positive electrode mixture layer, 34 Positive electrode current collector exposed part, 40 Negative electrode current collector, 42 Negative electrode mixture layer, 44 Negative electrode current collector exposed part.

1. A non-aqueous electrolyte secondary battery, comprising:
a wound electrode assembly in which a band-shaped positive electrode and a band-shaped negative electrode are wound with a separator interposed therebetween; and
an exterior housing can that houses the electrode assembly, wherein
the positive electrode has a positive electrode mixture layer formed on a surface of a sheet-shaped positive electrode current collector,
the negative electrode has a negative electrode mixture layer formed on a surface of a sheet-shaped negative electrode current collector,
the negative electrode mixture layer includes a rechargeable active material and a binder,
the negative electrode has a both-surface coated portion in which the negative electrode mixture layer is formed on both surfaces of the negative electrode current collector, and a one-surface coated portion in which the negative electrode mixture layer is formed on one surface of the negative electrode current collector,
at least a part of the one-surface coated portion is disposed on an outermost circumference of the electrode assembly,
at least a part of an exposed surface of the negative electrode current collector in the one-surface coated portion is contacted with an inner face of the exterior housing can, and
a degree of swelling of the binder by an electrolyte liquid in the one-surface coated portion is larger than a degree of swelling of the binder in the both-surface coated portion.

2. The non-aqueous electrolyte secondary battery according to claim 1, wherein the degree of swelling of the binder in the one-surface coated portion is 1.2 to 2.1 times larger than the degree of swelling of the binder in the both-surface coated portion.

3. The non-aqueous electrolyte secondary battery according to claim 1, wherein the binder is a styrene-butadiene rubber.

4. The non-aqueous electrolyte secondary battery according to claim 1, wherein the negative electrode mixture layer includes a silicon material.
